(19) United States
(12) Patent Application Publication
(10) Pub. No.: US 2012/0132443 A1
(43) Pub. Date: May 31, 2012

(54) PROCESS FOR THE REMOVAL OF CARBON DIOXIDE AND/OR HYDROGEN SULPHIDE FROM A GAS

(76) Inventor: Jiri Peter Thomas Van Straelen, Amsterdam (NL)

(21) Appl. No.: 13/377,988

(22) PCT Filed: Jun. 18, 2010
(86) PCT No.: PCT/EP10/58656

§ 371 Date: Jan. 16, 2012

(30) Foreign Application Priority Data
Jun. 19, 2009 (JP) 09163280.2

(51) Int. Cl. E21B 43/16; B01D 53/14; B01D 53/96; B01D 53/62; B01D 53/52

(52) U.S. Cl. 166/402; 423/220; 423/228; 423/232; 95/183; 95/181; 95/173

(57) ABSTRACT

A process for the removal of CO₂ and/or H₂S from a gas comprising CO₂ and/or H₂S. The process comprises contacting the gas in an absorber with an absorbing solution wherein the absorbing solution absorbs at least part of the CO₂ and/or H₂S so as, to produce a CO₂ and/or H₂S lean gas and a CO₂ and/or H₂S rich absorbing solution. At least part of the CO₂ and/or H₂S rich absorbing solution is heated to produce a heated CO₂ and/or H₂S rich absorbing solution. At least part of the CO₂ and/or H₂S is removed from the heated CO₂ and/or H₂S rich absorbing solution in a regenerator to produce a CO₂ and/or H₂S rich gas and a CO₂ and/or H₂S lean absorbing solution. In the process, at least part of the heat for heating the CO₂ and/or H₂S rich absorbing solution in step b) is obtained in a sequence of multiple heat exchangers.

### FIELD OF THE INVENTION

The invention relates to a process for removal of carbon dioxide (CO₂) and/or hydrogen sulphide (H₂S) from a gas.

### BACKGROUND OF THE INVENTION

During the last decades there has been a substantial global increase in the amount of CO₂ emission to the atmosphere. Emissions of CO₂ into the atmosphere are thought to be harmful due to its “greenhouse gas” property, contributing to global warming. Following the Kyoto agreement, CO₂ emission has to be reduced in order to prevent or counteract unwanted changes in climate. The largest sources of CO₂ emission are combustion of fossile fuels, for example coal or natural gas, for electricity generation and the use of petroleum products as a transportation and heating fuel. These processes result in the production of gases comprising CO₂. Thus, removal of at least part of the CO₂ prior to emission of these gases into the atmosphere is desirable.

In addition, it is necessary to avoid the emission of sulphur compounds into the environment.

Processes for removal of CO₂ and/or H₂S are known in the art.

For example, in WO 2006/022885, a process for removal of CO₂ from combustion gases is described, wherein an ammoniated slurry or solution is used. A disadvantage of this process is that the heating of a volatile solvent such as ammonia is energy intensive. In addition the volatility of the solvent will inevitably results in solvent losses. Another disadvantage is that the solvent needs to be cooled again to relatively low temperatures, requiring chilling duty in many locations.

WO 2008/072979 describes a method for capturing CO₂ from exhaust gas in an absorber, wherein the CO₂ containing gas is passed through an aqueous absorbent slurry comprising an inorganic alkali carbonate, bicarbonate and at least one of an absorption promoter and a catalyst, wherein the CO2 is converted to solids by precipitation in the absorber. The slurry is conveyed to a separating device in which the solids are separated off. The solids are sent to a heat exchanger, where it is heated and sent to a desorber. In the desorber it is heated further to the desired desorber temperature. A disadvantage of this process is that the heating of the solids before and in the desorber is energy intensive, especially when a reboiler is used.

Thus, there remains a need for an improved simple and energy-efficient process for removal of CO₂ and/or H₂S from gases.

### SUMMARY OF THE INVENTION

The invention provides a process for the removal of CO₂ and/or H₂S from a gas comprising CO₂ and/or H₂S, the process comprising the steps of:

(a) contacting the gas in an absorber with an absorbing solution wherein the absorbing solution absorbs at least part of the CO₂ and/or H₂S in the gas, to produce a CO₂ and/or H₂S lean gas and a CO₂ and/or H₂S rich absorbing solution;
(b) heating at least part of the CO₂ and/or H₂S rich absorbing solution to produce a heated CO₂ and/or H₂S rich absorbing solution;
(c) removing at least part of the CO₂ and/or H₂S from the heated CO₂ and/or H₂S rich absorbing solution in a regenerator to produce a CO₂ and/or H₂S rich gas and a CO₂ and/or H₂S lean absorbing solution;
wherein at least part of the heat for heating the CO₂ and/or H₂S rich absorbing solution in step b) is obtained in a sequence of multiple heat exchangers.

The process advantageously enables a simple, energy-efficient removal of CO₂ and/or H₂S from gases by using energy obtained at a low temperature.

The process is further especially advantageous when the CO₂ and/or H₂S rich absorbing solution contains solid compounds that need to be at least partly solved and/or converted to their liquid form, before removing at least part of the CO₂ and/or H₂S thereof in a regenerator, since their solvation and/or conversion to their liquid form requires extra energy.

The process is especially suitable for flue gas streams.

### BRIEF DESCRIPTION OF THE DRAWINGS

The invention is illustrated by the following figure:

FIG. 1 schematically shows a process scheme for one embodiment according to the invention.

### DETAILED DESCRIPTION OF THE INVENTION

The sequence of multiple heat exchangers may comprise two or more heat exchangers and preferably comprises in the range from two to five, more preferably in the range from two to three heat exchangers. In the heat exchangers any source of heat that is capable of heating the CO₂ and/or H₂S rich absorbing solution can be applied. For example, in the heat exchangers in step (b) the CO₂ and/or H₂S rich absorbing solution may be heated by heat obtained from the CO₂ and/or H₂S lean absorbing solution obtained in step (c) and/or one or more other sources than the CO₂ and/or H₂S lean absorbing solution.

When heating the CO₂ and/or H₂S rich absorbing solution with heat obtained by cooling the CO₂ and/or H₂S lean absorbing solution produced in step (c), advantageously the CO₂ and/or H₂S lean absorbing solution produced in step (c) is simultaneously cooled.

Examples of heat sources other than the CO₂ and/or H₂S lean absorbing solution include hot flue gas, heat generated in a condenser of the regenerator, heat generated in the cooling of compressors.

Preferably the sequence of multiple heat exchangers comprises at least one heat exchanger using heat obtained by cooling the CO₂ and/or H₂S lean absorbing solution from step (c) and at least one heat exchanger using heat from one or more heat sources other than the CO₂ and/or H₂S lean absorbing solution. Most preferably the sequence of multiple heat exchangers comprises a first heat exchanger, where the CO₂ and/or H₂S rich absorbing solution is heated in a first step by exchanging heat with the CO₂ and/or H₂S lean absorbing solution produced in step (c); a second heat exchanger, where the CO₂ and/or H₂S rich absorbing solution is heated in a second step using heat from one or more heat sources other than the CO₂ and/or H₂S lean absorbing solution; and/or a third heat exchanger, where the CO₂ and/or H₂S rich absorbing solution is heated in a third step by exchanging heat with the CO₂ and/or H₂S lean absorbing solution.

The absorbing solution in step (a) can be any absorbing solution capable of removing CO₂ and/or H₂S from a gas stream. Such absorbing solutions may include chemical and physical solvents or combinations of these. Suitable physical solvents include dimethylether compounds of polyethylene glycol. Suitable chemical solvents include ammonia and other amine compounds. For example, the absorbing solution can comprises one or more amines selected from the group of monoethanolamine (MEA), diethanolamine (DEA), diglycolamine (DGA), triethanolamine (TEA), N-ethyldiethanolamine (EDEA), methyldiethanolamine (MDEA), N,N′-di(hydroxyalkyl)piperazine, N,N,N′,N′-tetrakis(hydroxyalkyl)-1,6-hexanediamine and tertiary alkylamine sulfonic acid compounds (for example 4-(2-hydroxyethyl)-1-piperazineethanesulfonic acid, 4-(2-hydroxyethyl)-1-piperazinepropanesulfonic acid, 4-(2-hydroxyethyl)piperazine-1-(2-hydroxypropanesulfonic acid) and 1,4-piperazinedi(sulfonic acid)).

Preferably the absorbing solution in step a) comprises an aqueous solution of one or more carbonate compounds, wherein the absorbing solution absorbs at least part of the CO₂ and/or H₂S in the gas by reacting at least part of the CO₂ and/or H₂S in the gas with at least part of the one or more carbonate compounds in the aqueous solution to prepare a CO₂ and/or H₂S rich absorbing solution comprising a bisulphide and/or bicarbonate compound.

In one embodiment, the absorber is operated under conditions such that the bisulphide and/or bicarbonate compound stays in solution. The CO₂ and/or H₂S rich absorbing solution comprising the dissolved bisulphide and/or bicarbonate produced by the absorber can subsequently be cooled to form bicarbonate crystals.

In another embodiment, especially when CO₂ is being removed, the absorber is operated under conditions such that at least a part of the bicarbonate compound formed precipitates, such that a CO₂ and/or H₂S rich absorbing solution is produced, which CO₂ and/or H₂S rich absorbing solution comprises a bicarbonate slurry.

The aqueous solution of one or more carbonate compounds preferably comprises in the range of from 2 to 80 wt %, more preferably in the range from 5 to 75 wt %, and most preferably in the range from 10 to 70 wt % of carbonate compounds.

The one or more carbonate compounds can comprise any carbonate compound that can react with CO₂ and/or H₂S. Preferred carbonate compounds include alkali or alkali earth carbonates, such as Na₂CO₃ or K₂CO₃ or a combination thereof, as these compounds are relatively inexpensive, commercially available and show favourable solubilities in water.

The aqueous solution of one or more carbonate compounds can further comprise an accelerator to increase the rate of absorption of CO₂ and/or H₂S. Suitable accelerators include compounds that enhance the rate of absorption of CO₂ and/or H₂S from the gas into the liquid. The accelerator can for example be a primary or secondary amine, a vanadium-containing or a borate-containing compound or combinations thereof. Preferably an accelerator comprises one or more compounds selected from the group of vanadium-containing compounds, borate-containing compounds, monoethanolamine (MEA) and saturated 5- or 6-membered N-heterocyclic compounds, which optionally contain further heteroatoms. More preferably, the accelerator comprises one or more compounds selected from the group of MEA, piperazine, methylpiperazine and morpholine.

Without wishing to be bound by any kind of theory, it is believed that the process of the invention is especially advantageous in the case where the CO₂ and/or H₂S rich absorbing solution comprises a bicarbonate slurry, because solving the precipitated bicarbonate compound particles will require extra energy. The process according to the invention allows the use of energy obtained at a low temperature to dissolve bicarbonate crystals. The process is furthermore especially suitable for the removal of CO₂ from a gas comprising CO₂ as in such a process for removing CO₂ more bicarbonate crystals may be formed.

When the CO₂ and/or H₂S rich absorbing solution comprises a bicarbonate compound, a bisulphide compound, and/or a bicarbonate slurry, the process preferably comprises an additional step of subjecting at least part of the produced CO₂ and/or H₂S rich absorbing solution to a concentration step to obtain an aqueous solution and a concentrated CO₂ and/or H₂S rich absorbing solution; and returning at least part of the aqueous solution to the absorber. The concentrated CO₂ and/or H₂S rich absorbing solution preferably comprises in the range of from 20 to 80 wt % of bicarbonate compounds, preferably in the range of from 30 to 70 wt % of bicarbonate compounds, and more preferably in the range from 35 to 65 wt % of bicarbonate compounds.

Preferably such a process further comprises an additional step of pressurising the, preferably concentrated, CO₂ and/or H₂S rich absorbing solution to obtain a pressurised CO₂ and/or H₂S rich absorbing solution; subsequently heating the pressurised, CO₂ and/or H₂S rich absorbing solution in step b); and removing at least part of the CO₂ and/or H₂S from the heated pressurised CO₂ and/or H₂S rich absorbing solution in a regenerator in step c) to produce a CO₂ and/or H₂S rich gas and a CO₂ and/or H₂S lean absorbing solution, which CO₂ and/or H₂S lean absorbing solution comprises an aqueous solution of one or more carbonate compounds.

In addition to the steps (a), (b) and (c), the process according to the invention preferably further comprises a step (d) wherein the CO₂ and/or H₂S lean absorbing solution produced in step c) is cooled to produce a cooled CO₂ and/or H₂S lean absorbing solution. Preferably the process even further comprises a step e) wherein the cooled CO₂ and/or H₂S lean absorbing solution produced in step d) is recycled to step a) to be contacted with the gas in the absorber.

In the process of the invention the regenerator is preferably operated at a higher temperature than the absorber. Preferably, step (a) is operated at a temperature T1; at least part of the CO₂ and/or H₂S rich absorbing solution obtained in step (a) is heated in step (b) to a temperature T2, which is higher than T1; and at least part of the CO₂ and/or H₂S from the heated CO₂ and/or H₂S rich absorbing solution obtained in step (b) is removed in step (c) in a regenerator at a temperature T3, which is higher or equal to T2. The CO₂ and/or H₂S lean absorbing solution obtained in step (c) can subsequently be cooled in one or more heat exchangers, preferably to a temperature T1.

Preferably, the absorber is operated at a temperature in the range of from 10 to 80° C., more preferably from 20 to 80° C., and still more preferably from 20 to 60° C.

Preferably, the regenerator is operated at a temperature sufficiently high to ensure that a substantial amount of CO₂ and/or H₂S is liberated from the heated CO₂ and/or H₂S rich absorption liquid. Preferably, the regenerator is operated at a temperature in the range from 60 to 170° C., more preferably from 70 to 160° C. and still more preferably from 80 to 140° C.

In the process of the invention the regenerator is preferably operated at a higher pressure than the absorber. Preferably the regenerator is operated at elevated pressure, preferably in the range of from 1.0 to 50 bar, more preferably from 1.5 to 50 bar, still more preferably from 3 to 40 bar, even more preferably from 5 to 30 bar. Higher operating pressures for the regenerator are preferred because the CO₂ and/or H₂S rich gas exiting the renegerator will then also be at a high pressure.

Preferably the CO₂ and/or H₂S rich gas produced in step (c) is at a pressure in the range of from 1.5 to 50 bar, preferably from 3 to 40 bar, more preferably from 5 to 30 bar. Especially in applications where a CO₂ and/or H₂S rich gas needs to be at a high pressure, for example when it will be used for injection into a subterranean formation, it is an advantage that such CO₂ and/or H₂S rich gas is already at an elevated pressure as this reduces the equipment and energy requirements needed for further pressurisation.

In a preferred embodiment, pressurised CO₂ rich gas stream is used for enhanced oil recovery, suitably by injecting it into an oil reservoir where it tends to dissolve into the oil in place, thereby reducing its viscosity and thus making it more mobile for movement towards the producing well.

Optionally, the CO₂ and/or H₂S rich gas obtained in step (c) is compressed to a pressure in the range of from 60 to 300 bar, more preferably from 80 to 300 bar. A series of compressors can be used to pressurise the CO₂ and/or H₂S rich gas to the desired high pressures. A CO₂ and/or H₂S rich gas which is already at elevated pressure is easier to further pressurise. Moreover, considerable capital expenditure is avoided because the first stage(s) of the compressor, which would have been needed to bring the CO₂ and/or H₂S rich gas to a pressure in the range of 5 to 50 bar, is not necessary.

The gas comprising CO₂ and/or H₂S contacted with the absorbing solution in step (a) can be any gas comprising CO₂ and/or H₂S. Examples include flue gases, synthesis gas and natural gas. The process is especially capable of removing CO₂ and/or H₂S from flue gas streams, more especially flue gas streams having relatively low concentrations of CO₂ and/or H₂S and comprising oxygen.

The partial pressure of CO₂ and/or H₂S in the CO₂ and/or H₂S comprising gas contacted with the absorbing solution in step (a) is preferably in the range of from 10 to 500 mbar, more preferably in the range from 30 to 400 mbar and most preferably in the range from 40 to 300 mbar.

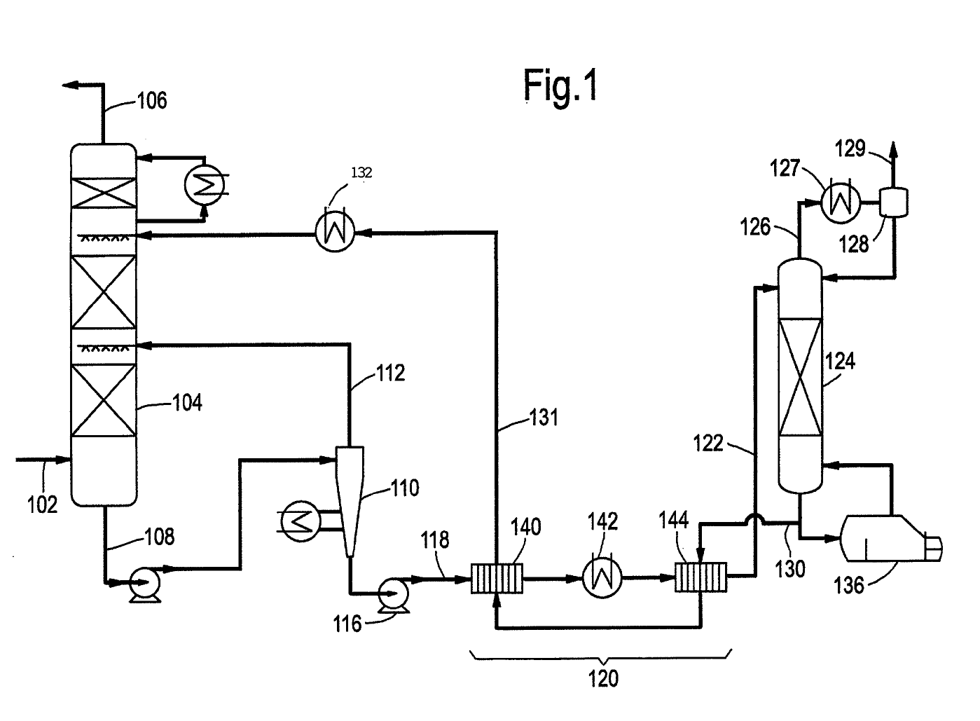

An embodiment of the present invention will now be described by way of example only, and with reference to the accompanying non-limiting drawing of FIG. 1. For the purpose of this description, a single reference number will be assigned to a line as well as stream carried in that line.

In FIG. 1 a gas comprising CO₂ is contacted with an aqueous solution comprising of one or more carbonate compounds in an absorber. The FIGURE shows a preferred embodiment wherein flue gas having a temperature of 40° C. and comprising about 7.6% of CO₂ is led via line (102) to absorber (104), where it is contacted with an aqueous solution of one or more carbonate compounds. In the absorber, CO₂ is reacted with the carbonate compounds to form bicarbonate compounds. At least part of the bicarbonate compounds precipitate to form a bicarbonate slurry. Treated gas, now comprising only 0.8% of CO₂ leaves the absorber via line (106). The bicarbonate slurry at a temperature of about 45° C. is withdrawn from the bottom of the absorber and led via line (108) to a concentrating device (110). In the concentrating device (110), aqueous solution is separated from the bicarbonate slurry and led back to the absorber via line (112) at a temperature of about 35° C. The resulting concentrated slurry is led at a temperature of about 35° C. from the concentrating device via line (114) and pressurised to a pressure of about 15 bar in pump (116). The pressurised concentrated bicarbonate slurry is led via line (118) to a series of heat exchangers (120), where it is heated from a temperature of about 35° C. to a temperature of about 90° C. The heated concentrated bicarbonate slurry is led via line (122) to regenerator (124), where it is further heated to release CO₂ from the slurry. The regenerator (124) is operated at about 90° C. and 1.1 bar. Heat is supplied to the regenerator via reboiler (136) heating the solution in the lower part of the regenerator (124) to 110° C. The released CO₂ is led from the regenerator via line (126) to a condenser (127) and vapour-liquid separator (128) and is obtained as a CO₂-rich stream (129) comprising about 99% of CO₂ at a temperature of about 40° C. A CO₂ lean aqueous solution of one or more carbonate compounds (i.e. a CO2 lean absorption solution) is led at a temperature of about 110° C. from the regenerator via line (130) to the series of heat exchangers (120), where it is cooled to a temperature of about 43° C. The cooled CO₂ lean absorption solution is led via line (131) to lean solvent cooler (132) where it is further cooled to a temperature of about 40° C. and led to the absorber (104).

In the sequence of multiple heat exchangers (120), the pressurised concentrated bicarbonate slurry is stepwise heated from a temperature of about 35° C. to a temperature of about 90° C. The sequence of heat exchangers (120), illustrated in FIG. 1 comprises a first heat exchanger (140), where pressurised concentrated bicarbonate slurry having a temperature of 35° C. is heated in a first step to a temperature of 53° C. by exchanging heat with CO2 lean absorption solution having a temperature of 75° C.; a second heat exchanger (142), where the pressurised concentrated bicarbonate slurry having a temperature of 53° C. is heated in a second step to a temperature of 70° C. using heat from another source than the CO2 lean absorption solution, for example heat from a hot flue gas, heat obtained from the regenerator condenser or heat obtained by interstage cooling from compressors; and a third heat exchanger (144), where the pressurised concentrated bicarbonate slurry having a temperature of 70° C. is heated in a third step to a temperature of 90° C. by exchanging heat with CO₂ lean absorption solution having a temperature of 110° C.

The CO₂ lean absorption solution from line (130) having a temperature of 110° C. is initially cooled in the third heat exchanger (144) to a temperature of 75° C. and subsequently in the first heat exchanger (142) to a temperature of about 43° C., advantageously reducing the cooling requirement for cooler (132), which only needs to cool from 43° C. to 40° C.

The sequence of multiple heat exchangers in FIG. 1 advantageously allows the use of heat at 53° C. to 70° C. to dissolve the bicarbonate crystals.

Using such a sequence of multiple heat exchangers further has the advantage that an increased amount of energy and/or heat needed can be provided by the CO₂ lean absorption solution and an other heat source in the process line up, thereby allowing the reboiler (136) for the regenerator to be of a smaller size.

As an example, calculations and simulations were done to confirm the benefit of the line-up for a three phase separation process containing gas, solids and liquid.

The following examples will illustrate the invention. Calculations and simulations were done to confirm the benefit of the line-up according to the invention for a three phase separation process containing gas, solids and liquid. The absorbing solution in this example is heated from 35° C. to 90° C. to enter the regenerator column at a temperature of 90° C.

### Example 1

### Comparative

In a conventional line-up, a first single lean rich heat exchanger was used, followed by a fat solvent heater, which is used to dissolve the solids present in the absorbing solution, before entering the regenerator column. The first single lean rich heat exchanger heated the absorbent from 35 to 73° C., using the heated solvent returning from the regenerator (the CO2 lean solvent). For this, 51 MW heat is required. Next, the absorbent was heated in the fat solvent heater, requiring a total of 22 MW of heat. To heat to this temperature with the fat solvent heater, an external heat medium was required in the temperature range 100-110° C., for example low pressure steam, coming from a source outside the line-up.

### Example 2

### According to the Invention

In the line-up according to FIG. 1, the so-called double lean rich heat exchanger design is being used, according to the claimed invention. To heat up the absorbent from 35° C. to 90° C. a first single lean rich heat exchanger was used, followed by a fat solvent heater, followed by a second lean rich heat exchanger, before entering the regenerator column.

The first single lean rich heat exchanger heated the absorbent from 35° C. to 53° C., by contacting with the CO2 lean solvent that was already used in the second heat exchanger. This required 24 MW of duty. The next heating step was contacting the absorbent in the fat solvent heater, to heat the absorbent from 53° C. to 70° C. This required a duty of 22 MW, for which an external heat medium was required. A number of waste-heat streams may be used for this purpose, for example the stream from the regenerator condenser or from a feed gas quench, or from interstage cooling of the compressors. Finally the absorbent was heated from 70° C. to 90° C. in the second lean rich heat exchanger, by contacting with the CO2 lean solvent directly from the regenerator.

This example demonstrates that energy obtained at a lower temperature from outside of the line-up can be used, and a better use of the heat of the CO2 lean solvent returning from the regenerator.

1. A process for the removal of CO₂ and/or H₂S from a gas comprising CO₂ and/or H₂S, the process comprising the steps of:
(a) contacting the gas in an absorber with an absorbing solution wherein the absorbing solution absorbs at least part of the CO₂ and/or H₂S in the gas, to produce a CO₂ and/or H₂S lean gas and a CO₂ and/or H₂S rich absorbing solution;
(b) heating at least part of the CO₂ and/or H₂S rich absorbing solution to produce a heated CO₂ and/or H₂S rich absorbing solution;
(c) removing at least part of the CO₂ and/or H₂S from the heated CO₂ and/or H₂S rich absorbing solution in a regenerator to produce a CO₂ and/or H₂S rich gas and a CO₂ and/or H₂S lean absorbing solution;
wherein at least part of the heat for heating the CO₂ and/or H₂S rich absorbing solution in step b) is obtained in a sequence of multiple heat exchangers.

2. The process of claim 1, wherein the sequence of multiple heat exchangers comprises a first heat exchanger, where the CO₂ and/or H₂S rich absorbing solution is heated in a first step by exchanging heat with the CO₂ and/or H₂S lean absorbing solution produced in step (c); a second heat exchanger, where the CO₂ and/or H₂S rich absorbing solution is heated in a second step using heat from one or more heat sources other than the CO₂ and/or H₂S lean absorbing solution; and/or a third heat exchanger, where the CO₂ and/or H₂S rich absorbing solution is heated in a third step by exchanging heat with the CO₂ and/or H₂S lean absorbing solution.

3. The process of claim 1, wherein the absorbing solution comprises ammonia or another amine compound.

4. The process of claim 1, wherein the absorbing solution in step a) comprises an aqueous solution of one or more carbonate compounds, wherein the absorbing solution absorbs at least part of the CO₂ and/or H₂S in the gas by reacting at least part of the CO₂ and/or H₂S in the gas with at least part of the one or more carbonate compounds in the aqueous solution to produce a CO₂ and/or H₂S rich absorbing solution comprising a bisulphide and/or bicarbonate compound.

5. The process of claim 4, wherein a bicarbonate compound is formed and the absorber is operated under conditions such that at least a part of the formed bicarbonate compound precipitates, to produce the CO₂ and/or H₂S rich absorbing solution, which CO₂ and/or H₂S rich absorbing solution comprises a bicarbonate slurry.

6. The process of claim 4, wherein the aqueous solution of one or more carbonate compounds comprises carbonate compounds in the range of from 2 to 80 wt %.

7. The process of claim 4, wherein the one or more carbonate compounds include Na₂CO₃ or K₂CO₃ or a combination thereof.

8. The process of claim 4, wherein the aqueous solution of one or more carbonate compounds further comprises an accelerator selected from the group of primary amines, secondary amines vanadium-containing compounds and borate-containing compounds.

9. The process of claim 4, comprising an additional step of subjecting at least part of the CO₂ and/or H₂S rich absorbing solution to the concentration step to obtain an aqueous solution and a concentrated CO₂ and/or H₂S rich absorbing solution, which concentrated CO₂ and/or H₂S rich absorbing solution optionally comprises a bicarbonate slurry; and
returning at least part of the aqueous solution to the absorber.

10. The process of claim 9, wherein the concentrated CO₂ and/or H₂S rich absorbing solution comprises in the range of from 20 to 80 wt % of bicarbonate compounds.

11. The process of claim 4, comprising an additional step of pressurising the, optionally concentrated, CO₂ and/or H₂S rich absorbing solution to obtain a pressurised CO₂ and/or H₂S rich absorbing solution;
subsequently heating the pressurised CO₂ and/or H₂S rich absorbing solution in step b) to produce a heated pressurised CO₂ and/or H₂S rich absorbing solution; and
removing at least part of the CO₂ and/or H₂S from the heated pressurised CO₂ and/or H₂S rich absorbing solution in a regenerator in step c) to produce a CO₂ and/or H₂S rich gas and a CO₂ and/or H₂S lean absorbing solution, which CO₂ and/or H₂S lean absorbing solution comprises an aqueous solution of one or more carbonate compounds.

12. The process of claim 1, further comprising a step (d) wherein the CO₂ and/or H₂S lean absorbing solution produced in step c) is cooled to produce a cooled CO₂ and/or H₂S lean absorbing solution.

13. The process of claim 12, further comprising a step e) wherein the cooled CO₂ and/or H₂S lean absorbing solution produced in step d) is recycled to step a) to be contacted with the gas in the absorber.

14. The process of claim 1, wherein the CO₂ and/or H₂S rich gas obtained in step (c) is compressed to a pressure in the range of from 60 to 300 bar.

15. The process of claim 14, wherein compressed CO₂ and/or H₂S rich gas is injected into a subterranean formation, preferably for use in enhanced oil recovery or for storage into an aquifer reservoir or for storage into an empty oil reservoir.
